(19) United States
(12) Patent Application Publication
(10) Pub. No.: US 2008/0104528 A1
(43) Pub. Date: May 1, 2008

(54) Capturing a GUI Display Environment

(76) Inventors: Bryan M. Logan, Rochester, MN (US); Terrence T. Nixa, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/554,258

(22) Filed: Oct. 30, 2006

(51) Int. Cl. G06F 3/048

(52) U.S. Cl. 715/764

(57) ABSTRACT

Methods, systems, and products are provided for capturing a GUI display environment. Embodiments include identifying a plurality of rendered GUI objects in the GUI display; selecting one or more GUI objects for non-functional re-rendering; selecting one or more GUI objects for functional re-rendering saving the content and display characteristics of each GUI object for non-functional re-rendering; saving the content, display characteristics, and at least one of the functional GUI characteristics of each GUI object for functional re-rendering; non-functionally re-rendering one or more of the GUI objects in dependence upon the saved content and display characteristics; and functionally re-rendering one or more of the GUI objects in dependence upon the saved content, display characteristics, and functional GUI characteristics.

### BACKGROUND OF THE INVENTION

1. Field of the Invention

The field of the invention is data processing, or, more specifically, methods, systems, and products for capturing a GUI display environment.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Current operating systems and stand-alone applications provide for limited screen captures. That is, conventional systems provide static images of the current rendering of GUI objects on a display. Such screen captures may be used to convey information about a program to another user for demonstration purposes or to show all the information a user sees for debug purposes. Such a screen capture can often convey more than a text or verbal description. However, a simple static screen capture is limited.

### SUMMARY OF THE INVENTION

Methods, systems, and products are provided for capturing a GUI display environment. Embodiments include identifying a plurality of rendered GUI objects in the GUI display; selecting one or more GUI objects for non-functional re-rendering; selecting one or more GUI objects for functional re-rendering; saving the content and display characteristics of each GUI object for non-functional re-rendering; saving the content, display characteristics, and at least one of the functional GUI characteristics of each GUI object for functional re-rendering; non-functionally re-rendering one or more of the GUI objects in dependence upon the saved content and display characteristics; and functionally re-rendering one or more of the GUI objects in dependence upon the saved content, display characteristics, and functional GUI characteristics.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer system for capturing a GUI display environment according to embodiments of the present invention.

FIG. 2 sets forth a flow chart illustrating an exemplary method for capturing a GUI display environment according to embodiments of the present invention.

FIG. 3 sets forth a block diagram of a GUI display screen having rendered upon it three GUI objects.

FIG. 4 sets forth a block diagram of a GUI display of a captured GUI display environment of FIG. 3.

FIG. 5 sets forth a flow chart illustrating another exemplary method for capturing a GUI display environment according to embodiments of the present invention.

### DETAILED DESCRIPTION OF EXEMPLARY EMBODIMENTS

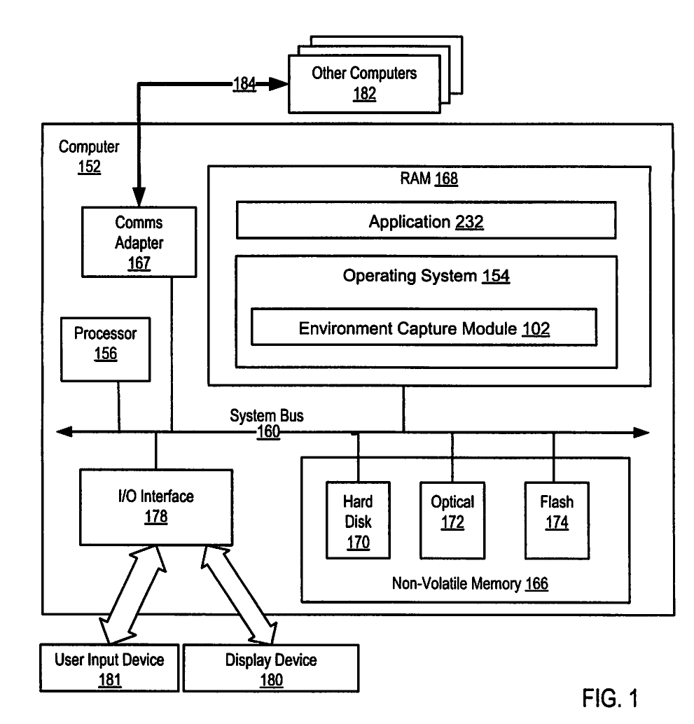

Exemplary methods, systems, and products for capturing a GUI display environment according to embodiments of the present invention are described with reference to the accompanying drawings, beginning with FIG. 1. FIG. 1 sets forth a block diagram of automated computing machinery comprising an exemplary computer (152) system for capturing a GUI display environment according to embodiments of the present invention. The system of FIG. 1 is capable of capturing a GUI display environment by identifying a plurality of rendered GUI objects in the GUI display; selecting one or more GUI objects for non-functional re-rendering; selecting one or more GUI objects for functional re-rendering; saving the content and display characteristics of each GUI object for non-functional re-rendering; saving the content, display characteristics, and at least one of the functional GUI characteristics of each GUI object for functional re-rendering; non-functionally re-rendering one or more of the GUI objects in dependence upon the saved content and display characteristics; and functionally re-rendering one or more of the GUI objects in dependence upon the saved content, display characteristics, and functional GUI characteristics.

The GUI display environment includes both visual presentation of the GUI display and GUI operability of the GUI display. Capturing a GUI display environment according to the present invention provides an enhanced re-rendering of aspects of the GUI display that includes both visual presentation of the GUI display and some GUI operability of the GUI display.

The computer (152) of FIG. 1 includes at least one computer processor (156) or ‘CPU’ as well as random access memory (168) (‘RAM’) which is connected through a system bus (160) to processor (156) and to other components of the computer. Stored in RAM (168) is an application (232), a software program designed to perform a specific task or group of tasks, such as word processing, communications, or database management.

Also stored in RAM (168) is an operating system (154). The operating system of FIG. 1 includes an environment capture module (102), computer program instructions for capturing a GUI display environment according to embodiments of the present invention including computer program instructions for identifying a plurality of rendered GUI objects in the GUI display; selecting one or more GUI objects for non-functional re-rendering; selecting one or more GUI objects for functional re-rendering; saving the content and display characteristics of each GUI object for non-functional re-rendering; saving the content, display characteristics, and at least one of the functional GUI characteristics of each GUI object for functional re-rendering; non-functionally re-rendering one or more of the GUI objects in dependence upon the saved content and display characteristics; and functionally re-rendering one or more of the GUI objects in dependence upon the saved content, display characteristics, and functional GUI characteristics. Operating systems capable of modification for capturing a GUI display environment according to embodiments of the present invention include UNIX®, Linux™, Microsoft XP™, IBM AIX™, and others as will occur to those of skill in the art.

The environment capture module (102) is shown in the operating system in the example of FIG. 1. This is for explanation, and not for limitation. In fact, environment capture modules in accordance with the present invention may in alternative embodiments reside outside of the operating system.

Computer (152) of FIG. 1 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 1 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 1 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful with systems for capturing a GUI display environment according to embodiments of the present invention include modems for wired dial-up communications, Ethernet (IEEE 802.3) adapters for wired network communications, and 802.11b adapters for wireless network communications.

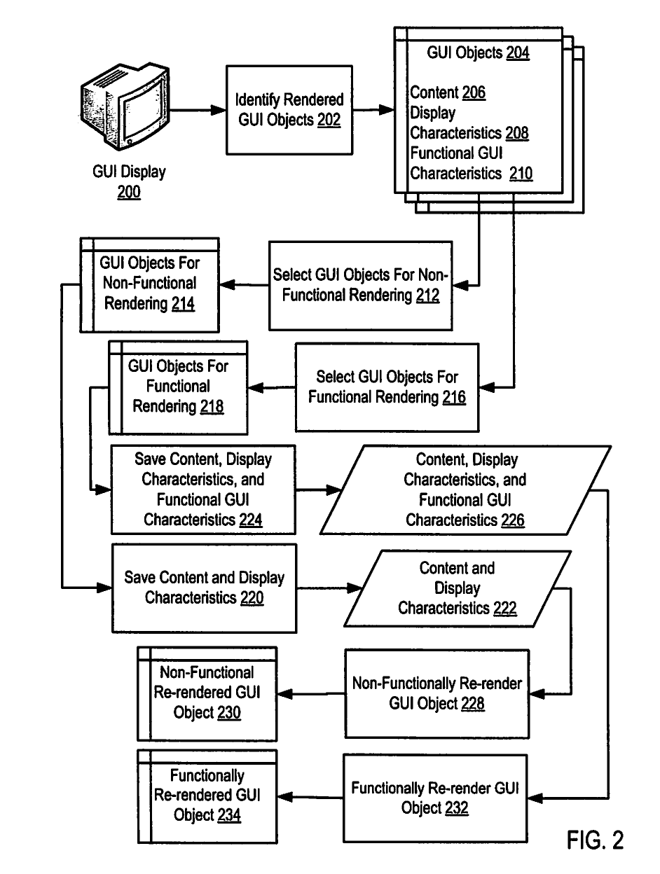

For further explanation, FIG. 2 sets forth a flow chart illustrating an exemplary method for capturing a GUI display environment according to embodiments of the present invention. The method of FIG. 2 includes identifying (202) a plurality of rendered GUI objects (204) in the GUI display (200). A graphical user interface (‘GUI’) object is implemented as one or more graphical user interface display elements for displaying the visual output an application to a user. A GUI object may comprise other GUI objects such as GUI controls, widgets, toolbars, scrollbars, and so on as will occur to those of skill in the art.

In the example of FIG. 2, each rendered GUI object (204) having content (206), display characteristics (208), and one or more functional GUI characteristics (210). Content (206) includes subject matter output of the application displayed in the GUI object such as for example text and images displayed in the GUI object. Content (206) may also include the text or symbol of a smaller GUI object such as for example a label on a GUI button. Display characteristics (208) are the visual characteristics of the GUI object, as well as other GUI objects or widgets within the GUI object. The display characteristics provide the look of the GUI object. Examples of such display characteristics include the look of GUI controls of the GUI object, the layout of the GUI object, the look of scrollbars of the GUI object and so on as will occur to those of skill in the art. Functional GUI characteristics (210) are the operational characteristics of the GUI object. Such operation characteristics include for example the functionality of a scrollbar, the functionality of a GUI button on the GUI object and so on.

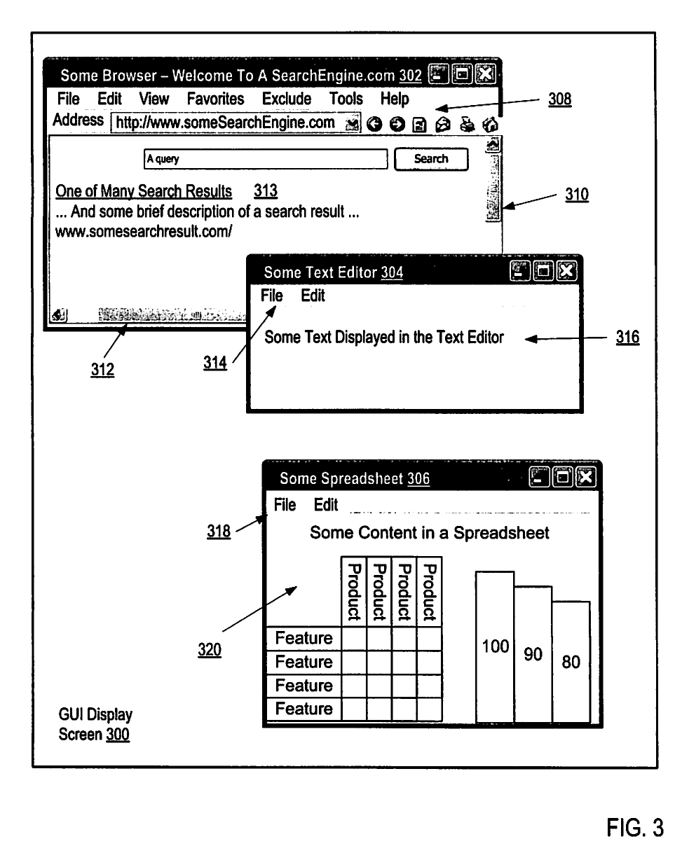

For further explanation, FIG. 3 sets forth a block diagram of a GUI display screen (300) having rendered upon it three GUI objects. The GUI objects include a GUI display of a web browser (302), a GUI display of a text editor (304), and the GUI display of a spreadsheet (306). The GUI object (302) displaying the web browser includes another GUI object of a toolbar (308) that has display characteristics defining the way the GUI controls, pull down menus, address bar and other aspects of the tool bar look and text content labeling even further GUI objects of pull down menus, GUI controls and so on. The GUI controls of the toolbar (308) have functional characteristics which define the operation of those GUI controls such as a back button that when invoked returns to the display of the last visited web page, a refresh button that refreshes the display of a web page and so on. The GUI object (302) also has additional GUI objects of a vertical scrollbar (310) and a horizontal scrollbar (312) having display characteristics defining the way the scrollbars (310 and 312) look and functional GUI characteristics defining the vertical operation of the vertical scroll bar (310) and the horizontal operation of the horizontal scroll bar (312). The GUI object (302) has rendered text content (313) describing a search result of a search engine displayed in the browser.

The example of FIG. 3 also includes a GUI object (304) for the visual display of a text editor. The GUI object (304) includes another GUI object of a toolbar (314) having display characteristics defining the look of the pull down menu for ‘File’ and ‘Edit’ and text content of labels of File and Edit The toolbar (314) has functional GUI characteristics defining the operation upon invocation of the pull down menus for ‘File’ and ‘Edit.’ The GUI object (304) also currently displays text content (316) as visual output of the text editor.

The example of FIG. 3 also includes a GUI object (306) for the visual display of a spreadsheet application. The GUI object (306) includes another GUI object of a toolbar (318) having display characteristics defining the look of the pull down menu for ‘File’ and ‘Edit’ and text content of labels of File and Edit. The toolbar (318) has functional GUI characteristics defining the operation upon invocation of the pull down menus for ‘File’ and ‘Edit.’ The GUI object (306) also has currently displayed graph and chart content (320) as visual output of the spreadsheet application.

The exemplary GUI objects of FIG. 3 are presented for explanation and not for limitation. GUI objects capable of being captured according to the present invention may vary widely and may include other GUI objects that may themselves be capture and alternatively be non-functionally re-rendered or functionally re-rendered in accordance with the present invention.

Again with reference to FIG. 2: After identifying (202) the GUI objects (204) rendered on the GUI display (200), the method of FIG. 2 also includes selecting (212) one or more GUI objects (214) for non-functional re-rendering. Non-functional re-rendering of the selected GUI objects is carried out by re-rendering aspects of the GUI object as it appears in the GUI display but without the functional GUI characteristics. For example, non-functional re-rendering of a toolbar of a GUI object having a number of GUI buttons will result in a GUI object having a substantially inoperable toolbar that looks the same.

Selecting (212) one or more GUI objects (214) for non-functional re-rendering may be carried out in dependence upon GUI object selection rules. Such GUI object selection rules may be designed to select for non-functional rendering certain GUI objects. For example, consider the following GUI object selection rule:

IF GUI object = ‘File Pull Down Menu’
THEN Re-Rendering = ‘Non-Functional’

In the exemplary GUI object selection rule above, all GUI objects that are ‘File Pull Down Menus’ are predetermined to be non-functionally re-rendered. The exemplary GUI object selection rule is presented for explanation and not for limitation. In fact, selecting (212) one or more GUI objects (214) for non-functional re-rendering may be carried out in a number of ways as will occur to those of skill in the art and all such ways are well within the scope of the present invention.

The method of FIG. 2 also includes selecting (216) one or more GUI objects (218) for functional re-rendering. Functional re-rendering of the selected GUI objects is carried out by re-rendering aspects of the GUI object as it appears in the GUI display and preserving the functional GUI characteristics. For example, a functional re-rendering of a toolbar of a GUI object having a number of GUI buttons will result in GUI object having a toolbar that looks the same and also functions with the operational capability of the GUI object.

Selecting (216) one or more GUI objects (218) for functional re-rendering may also be carried out in dependence upon GUI object selection rules. Such GUI object selection rules may be designed to select for functional re-rendering certain GUI objects. For example, consider the following GUI object selection rule:

IF GUI object = ‘scrollbar’
THEN Re-Rendering = ‘Functional’

In the exemplary GUI object selection rule above, all GUI objects that are ‘scrollbars’ are predetermined to be functionally re-rendered. The exemplary GUI object selection rule is presented for explanation and not for limitation. In fact, selecting (216) one or more GUI objects (218) for functional re-rendering may be carried out in a number of ways as will occur to those of skill in the art and all such ways are well within the scope of the present invention.

The method of FIG. 2 also includes saving (220) the content and display characteristics (222) of each GUI object (214) for non-functional re-rendering. Saving (220) the content and display characteristics (222) of each GUI object (214) for non-functional re-rendering may be carried out by saving a description of the content and display characteristics such as by saving an eXtensible Markup Language (‘XML’) description of the content and display characteristics for re-rendering using the same or similar applications used to originally render the GUI object. That is, non-functionally re-rendering the GUI object may be carried out using the same APIs used to originally render the GUI object but without calling the APIs providing the operational characteristics of the GUI object.

Saving (220) the content and display characteristics (222) of each GUI object (214) for non-functional re-rendering may be carried out by saving an image of the content and display characteristics. Such an image may be a static visual image of the content as it appears in the GUI object.

The method of FIG. 2 also includes saving (224) the content, display characteristics, and at least one of the functional GUI characteristics (226) of each GUI object (210) for functional re-rendering. Saving (224) the content, display characteristics, and at least one of the functional GUI characteristics (226) of each GUI object (210) for functional re-rendering may be carried out by saving a description of the content, the display characteristics of the GUI object for function rendering, and the at least one of the functional GUI characteristics. Such a description may be implemented as an XML description of the content, display characteristics, and functional GUI characteristics for re-rendering using the same or similar applications used to originally render the GUI object. That is, functionally re-rendering the GUI object may be carried out using the same APIs used to originally render the GUI object and, unlike non-functional re-rendering, also calling the APIs providing the operational characteristics of the GUI object.

Saving (224) the content, display characteristics, and at least one of the functional GUI characteristics (226) of each GUI object (210) for functional re-rendering may be carried out by saving an image of the content and display characteristics. Such an image may be a static visual image of the content as it appears in the GUI object. In such cases, however, to maintain the functional GUI characteristics additional display operability is provided to the image. Such additional display operability is designed to mimic the functional GUI characteristics of the original GUI object such as scrolling the displayed content, functionality of toolbars and GUI buttons and so on as will occur to those of skill in the art.

The method of FIG. 2 also includes non-functionally re-rendering (228) one or more of the GUI objects (214) in dependence upon the saved content and display characteristics (222). Non-functionally re-rendering (228) one or more of the GUI objects (214) in dependence upon the saved content and display characteristics (222) may be carried out using the same or similar applications used to originally render the GUI object. That is, non-functionally re-rendering the GUI object may be carried out using the same APIs used to originally render the GUI object but without calling the APIs providing the operational characteristics of the GUI object. Non-functionally re-rendering (228) one or more of the GUI objects (214) in dependence upon the saved content and display characteristics (222) may alternatively be carried out by saving an image of the content and display characteristics. Such an image may be a static visual image of the content as it appears in the GUI object.

The method of FIG. 2 also includes functionally re-rendering (232) one or more of the GUI objects (218) in dependence upon the saved content, display characteristics, and functional GUI characteristics (226). Functionally re-rendering (232) one or more of the GUI objects (218) in dependence upon the saved content, display characteristics, and functional GUI characteristics (226) may be carried out by re-rendering the GUI object using the same or similar applications used to originally render the GUI object. That is, functionally re-rendering the GUI object may be carried out using the same APIs used to originally render the GUI object and, unlike non-functional re-rendering, also calling the APIs providing the operational characteristics of the GUI object. Functionally re-rendering (232) one or more of the GUI objects (218) in dependence upon the saved content, display characteristics, and functional GUI characteristics (226) may alternatively be carried out by saving an image of the content and display characteristics and also providing additional display operability to the image. Such additional display operability is designed to mimic the functional GUI characteristics of the original GUI object such as scrolling the displayed content, functionality of toolbars and GUI buttons and so on as will occur to those of skill in the art.

To provide additional benefits to a user viewing the re-rendered objects of the captured GUI display environment, embodiments may also include providing additional display operability to the re-rendered objects. Providing additional display operability to the re-rendered objects may be carried out using, for example, virtual reality modeling languages or other graphics tools. Such additional display operability may include rotating re-rendered objects, visually enhancing re-rendered objects and others as will occur to those of skill in the art.

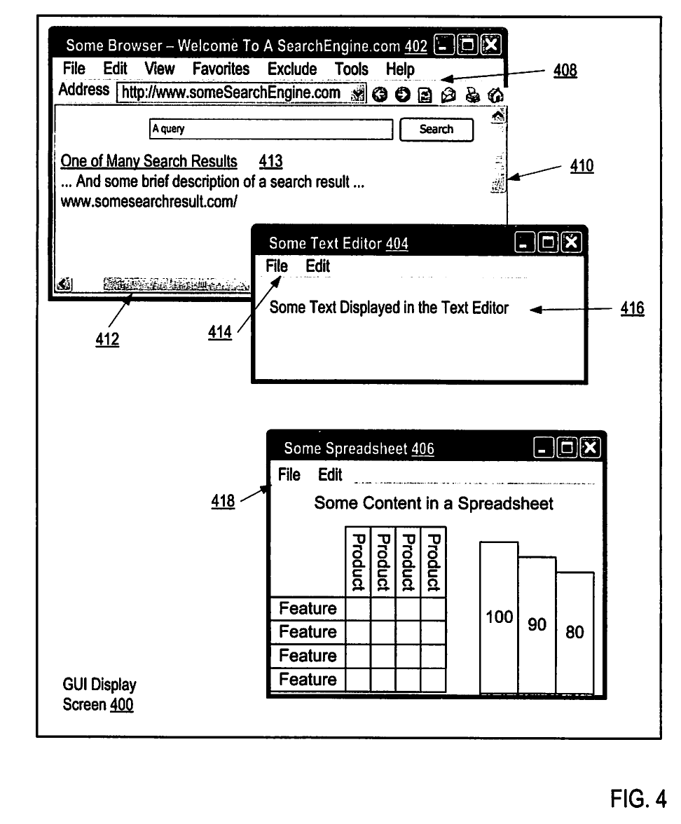

For further explanation, FIG. 4 sets forth a block diagram of a GUI display of a captured GUI display environment of FIG. 3. The captured GUI objects include the re-rendering (402) of the GUI display of a web browser of FIG. 3 (302 on FIG. 3), a re-rendering (404) of GUI display of a text editor of FIG. 3 (304 on FIG. 3), and a re-rendering (406) of the GUI display of a spreadsheet of FIG. 3 (306 on FIG. 3). The re-rendering (402) of the GUI object of FIG. 3 (302 on FIG. 3) displaying the web browser includes a non-functional re-rendering (408) of another GUI object of a toolbar (308 on FIG. 3) that is non-functionally re-rendered has according to the display characteristics defining the way the GUI controls, pull down menus, address bar and other aspects of the tool bar look and text content labeling even further non-functionally re-rendered GUI objects of pull down menus, GUI controls and so on. The toolbar (408) is non-functionally re-rendered such that the GUI controls and pull down menus are not functional. The re-rendering (402) of the GUI object (302 on FIG. 3) also has additional functionally re-rendered GUI objects of a vertical scrollbar (310 on FIG. 3) and a horizontal scrollbar (312 on FIG. 3). The functionally re-rendered scrollbars (410 and 412) operate to scroll both horizontally and vertically.

The example of FIG. 4 also includes a non-functional re-rendering (404) of a GUI object of FIG. 3 (304 on FIG. 3) for the visual display of a text editor. The non-functional re-rendering (404) of the GUI object (304 on FIG. 3) includes another non-functional re-rendering (414) GUI object of a toolbar (314 on FIG. 3) having the same display characteristics the pull down menu for ‘File’ and ‘Edit’ but not having the functionality of those pull down menus.

The example of FIG. 4 also includes a functional re-rendering (406) of a GUI object of FIG. 3 (306 on FIG. 3) for the visual display of a spreadsheet application. The functional re-rendering (406) of the GUI object (306 on FIG. 3) includes another functional re-rendering (418) of a GUI object of a toolbar (318 on FIG. 3) having the same display characteristics and also having the same functionality of the toolbar of FIG. 3.

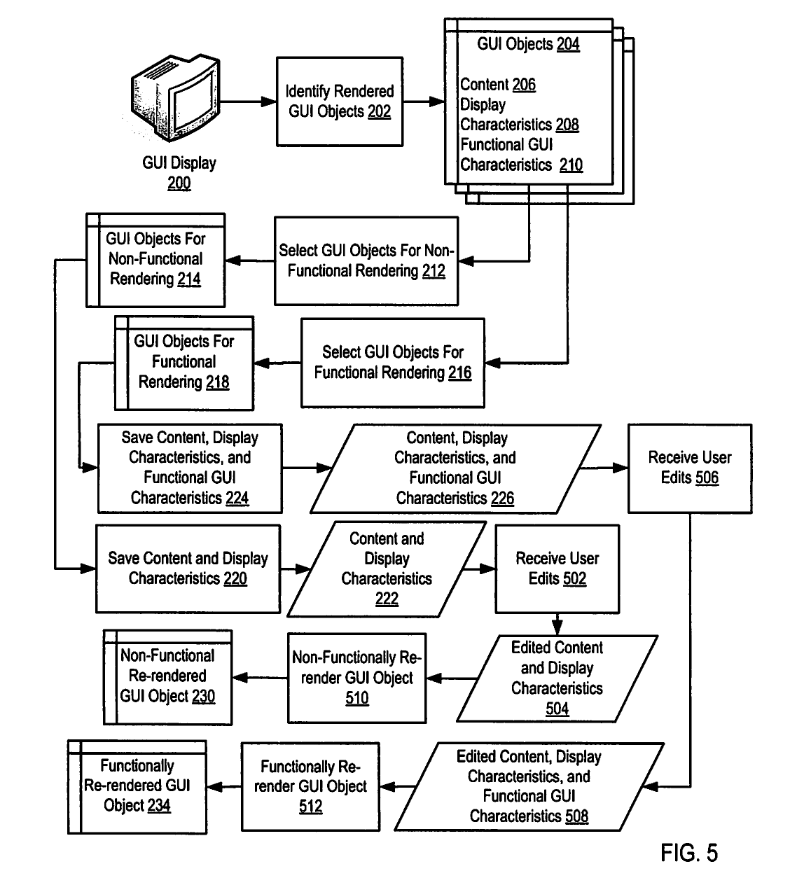

As mentioned above, the GUI objects selected and whether functional GUI characteristics are to be preserved or not for re-rendering may be automated in dependence upon GUI object selection rules. Such selected GUI objects and whether functional GUI characteristics are to be preserved may be usefully edited by a user. For further explanation, FIG. 5 sets forth a flow chart illustrating another exemplary method for capturing a GUI display environment according to embodiments of the present invention. The method of FIG. 5 is similar to the method of FIG. 2 in that the method of FIG. 5 includes identifying (202) a plurality of rendered GUI objects (204) in the GUI display (200); selecting (212) one or more GUI objects (214) for non-functional re-rendering; selecting (216) one or more GUI objects (218) for functional re-rendering; saving (220) the content and display characteristics (222) of each GUI object (214) for non-functional re-rendering; and saving (224) the content, display characteristics, and at least one of the functional GUI characteristics (226) of each GUI object (210) for functional re-rendering.

The method of FIG. 5 differs from the method of FIG. 2 in that the method of FIG. 5 also includes receiving (502) user edits (504) of the saved content and display characteristics, and in the method of FIG. 5, non-functionally re-rendering one or more of the GUI objects (214) in dependence upon the saved content and display characteristics is carried out by non-functionally re-rendering (510) one or more of the GUI objects in dependence upon the user edits (504). Receiving (502) user edits of the saved content and display characteristics may be carried out through a GUI editor designed to receive user edits to the saved content and display characteristics. Such user edits may include, for example, removing the GUI object from re-rendering entirely by for example setting the display characteristics to indicate no display of the GUI object.

The method of FIG. 5 also differs from the method of FIG. 2 in that the method of FIG. 5 also includes receiving (506) user edits (508) of the saved content, display characteristics, and functional GUI characteristics (226), and in the method of FIG. 5, functionally re-rendering one or more of the GUI objects (218) in dependence upon the saved content, display characteristics, and functional GUI characteristics is carried out by functionally re-rendering (512) one or more of the GUI objects in dependence upon the user edits (508). Receiving (506) user edits of the saved content, display characteristics, and functional GUI characteristics (226) may be carried out through a GUI editor designed to receive user edits to the saved content, display characteristics, and functional GUI characteristics. Such user edits may, for example, include removing the GUI object from re-rendering entirely by for example setting the display characteristics to indicate no display of the GUI object. Such user edits may, for example, include altering the functional GUI characteristics thereby changing the functionality of the GUI object upon re-rendering.

Exemplary embodiments of the present invention are described largely in the context of a fully functional computer system for capturing a GUI display environment. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web.

Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for capturing a GUI display environment, the method comprising:
identifying a plurality of rendered GUI objects in the GUI display;
each rendered GUI object having content, display characteristics, and one or more functional GUI characteristics;
selecting one or more GUI objects for non-functional re-rendering;
selecting one or more GUI objects for functional re-rendering;
saving the content and display characteristics of each GUI object for non-functional re-rendering;
saving the content, display characteristics, and at least one of the functional GUI characteristics of each GUI object for functional re-rendering;
non-functionally re-rendering one or more of the GUI objects in dependence upon the saved content and display characteristics; and
functionally re-rendering one or more of the GUI objects in dependence upon the saved content, display characteristics, and functional GUI characteristics.

2. The method of claim 1 further comprising receiving user edits of the saved content and display characteristics; and
wherein non-functionally re-rendering one or more of the GUI objects in dependence upon the saved content and display characteristics further comprises non-functionally re-rendering one or more of the GUI objects in dependence upon the user edits.

3. The method of claim 1 further comprising receiving user edits of the saved content, display characteristics, and functional GUI characteristics; and
wherein functionally re-rendering one or more of the GUI objects in dependence upon the saved content, display characteristics, and functional GUI characteristics further comprises functionally re-rendering one or more of the GUI objects in dependence upon the user edits.

4. The method of claim 1 wherein:
saving the content, display characteristics, and at least one of the functional GUI characteristics of each GUI object for functional re-rendering further comprises saving a description of the content, the display characteristics of the GUI object for function rendering, and the at least one of the functional GUI characteristics; and
functionally re-rendering one or more of the GUI objects in dependence upon the saved content, display characteristics, and functional GUI characteristics further comprises recreating, for each GUI object for functional re-rendering, a new GUI object in dependence upon the description of the content. display characteristics, and functional GUI characteristics.

5. The method of claim 1 wherein
saving the content, display characteristics, and at least one of the functional GUI characteristics of each GUI object for functional re-rendering further comprises creating an image of the content and the display characteristics of each GUI object; and
functionally re-rendering one or more of the GUI objects in dependence upon the saved content, display characteristics, and functional GUI characteristics further comprises rendering the image and providing added display operability designed to mimic aspects of the functional GUI characteristics.

6. The method of claim 1 further comprising providing additional display operability to one or more of the re-rendered objects.

7. A system for capturing a GUI display environment, the system comprising:
a computer processor;
a computer memory operatively coupled to the computer processor, the computer memory having disposed within it computer program instructions capable of:
identifying a plurality of rendered GUI objects in the GUI display;
each rendered GUI object having content, display characteristics, and one or more functional GUI characteristics;
selecting one or more GUI objects for non-functional re-rendering;
selecting one or more GUI objects for functional re-rendering;
saving the content and display characteristics of each GUI object for non-functional re-rendering;
saving the content, display characteristics, and at least one of the functional GUI characteristics of each GUI object for functional re-rendering;
non-functionally re-rendering one or more of the GUI objects in dependence upon the saved content and display characteristics; and
functionally re-rendering one or more of the GUI objects in dependence upon the saved content, display characteristics, and functional GUI characteristics.

8. The system of claim 7 wherein the computer memory also has disposed within it computer program instructions capable of:
receiving user edits of the saved content and display characteristics; and
and wherein computer program instructions capable of non-functionally re-rendering one or more of the GUI objects in dependence upon the saved content and display characteristics further comprise computer program instructions capable of non-functionally re-rendering one or more of the GUI objects in dependence upon the user edits.

9. The system of claim 7 wherein the computer memory also has disposed within it computer program instructions capable of:
receiving user edits of the saved content, display characteristics, and functional GUI characteristics; and
wherein computer program instructions capable of functionally re-rendering one or more of the GUI objects in dependence upon the saved content, display characteristics, and functional GUI characteristics further comprise computer program instructions capable of functionally re-rendering one or more of the GUI objects in dependence upon the user edits.

10. The system of claim 7 wherein:
computer program instructions capable of saving the content, display characteristics, and at least one of the functional GUI characteristics of each GUI object for functional re-rendering further comprise computer program instructions capable of saving a description of the content, the display characteristics of the GUI object for function rendering, and the at least one of the functional GUI characteristics; and
computer program instructions capable of functionally re-rendering one or more of the GUI objects in dependence upon the saved content, display characteristics, and functional GUI characteristics further comprise computer program instructions capable of recreating, for each GUI object for functional re-rendering, a new GUI object in dependence upon the description of the content. display characteristics, and functional GUI characteristics.

11. The system of claim 7 wherein
computer program instructions capable of saving the content, display characteristics, and at least one of the functional GUI characteristics of each GUI object for functional re-rendering further comprise computer program instructions capable of creating an image of the content and the display characteristics of each GUI object; and
computer program instructions capable of functionally re-rendering one or more of the GUI objects in dependence upon the saved content, display characteristics, and functional GUI characteristics further comprise computer program instructions capable of rendering the image and providing added display operability designed to mimic aspects of the functional GUI characteristics.

12. The system of claim 7 wherein the computer memory also has disposed within it computer program instructions capable of providing additional display operability to one or more of the re-rendered objects.

13. A computer program product for capturing a GUI display environment, the computer program product embodied on a computer-readable medium, the computer program product comprising:
computer program instructions for identifying a plurality of rendered GUI objects in the GUI display;
each rendered GUI object having content, display characteristics, and one or more functional GUI characteristics;
computer program instructions for selecting one or more GUI objects for non-functional re-rendering;
computer program instructions for selecting one or more GUI objects for functional re-rendering;
computer program instructions for saving the content and display characteristics of each GUI object for non-functional re-rendering;
computer program instructions for saving the content, display characteristics, and at least one of the functional GUI characteristics of each GUI object for functional re-rendering;
computer program instructions for non-functionally re-rendering one or more of the GUI objects in dependence upon the saved content and display characteristics; and
computer program instructions for functionally re-rendering one or more of the GUI objects in dependence upon the saved content, display characteristics, and functional GUI characteristics.

14. The computer program product of claim 13 further comprising computer program instructions for receiving user edits of the saved content and display characteristics; and
wherein computer program instructions for non-functionally re-rendering one or more of the GUI objects in dependence upon the saved content and display characteristics further comprise computer program instructions for non-functionally re-rendering one or more of the GUI objects in dependence upon the user edits.

15. The computer program product of claim 13 further comprising computer program instructions for receiving user edits of the saved content, display characteristics, and functional GUI characteristics; and
wherein computer program instructions for functionally re-rendering one or more of the GUI objects in dependence upon the saved content, display characteristics, and functional GUI characteristics further comprise computer program instructions for functionally re-rendering one or more of the GUI objects in dependence upon the user edits.

16. The computer program product of claim 13 wherein:
computer program instructions for saving the content, display characteristics, and at least one of the functional GUI characteristics of each GUI object for functional re-rendering further comprise computer program instructions for saving a description of the content, the display characteristics of the GUI object for function rendering, and the at least one of the functional GUI characteristics; and
computer program instructions for functionally re-rendering one or more of the GUI objects in dependence upon the saved content, display characteristics, and functional GUI characteristics further comprise computer program instructions for recreating, for each GUI object for functional re-rendering, a new GUI object in dependence upon the description of the content. display characteristics, and functional GUI characteristics.

17. The computer program product of claim 13 wherein
computer program instructions for saving the content, display characteristics, and at least one of the functional GUI characteristics of each GUI object for functional re-rendering further comprise computer program instructions for creating an image of the content and the display characteristics of each GUI object; and
computer program instructions for functionally re-rendering one or more of the GUI objects in dependence upon the saved content, display characteristics, and functional GUI characteristics further comprise computer program instructions for rendering the image and providing added display operability designed to mimic aspects of the functional GUI characteristics.

18. The computer program product of claim 13 further comprising computer program instructions for providing additional display operability to one or more of the re-rendered objects.

19. The computer program product of claim 13 wherein the computer-readable medium comprises a recordable medium.

20. The computer program product of claim 13 wherein the computer-readable medium comprises a transmission medium.
